(19) United States
(12) Patent Application Publication
(10) Pub. No.: US 2023/0251433 A1
(43) Pub. Date: Aug. 10, 2023

(54) FIBER POSITIONING ARRANGEMENT FOR OPTICAL FIBERS

(71) Applicant: CommScope Technologies LLC, Hickory, NC (US)

(72) Inventors: Danny Willy August VERHEYDEN, Gelrode (BE); Jozef Christiaan Mathieu VERSLEEGERS, Bree (BE); Marc SCHOUTEDEN, Houthalen – Helchteren (BE); Peter VERSCHRAEGEN, Hoegaarden (BE); Stefano BERI, Zaventem (BE); Thierry Mike DECLERCK, Kumtich (BE)

(21) Appl. No.: 18/300,199

(22) Filed: Apr. 13, 2023

Related U.S. Application Data
(63) Continuation of application No. PCT/US2021/054524, filed on Oct. 12, 2021.
(60) Provisional application No. 63/091,070, filed on Oct. 13, 2020.

(51) Int. Cl. G02B 6/36; G02B 6/38

(52) U.S. Cl. CPC G02B 6/3636; G02B 6/3809

(57) ABSTRACT

The present disclosure relates generally to a positioning arrangement for positioning optical fibers. The positioning arrangement can include a positioning substrate with a plurality of fiber receiving locations arranged in a row. Each of the fiber receiving locations can be configured to receive one of the optical fibers. Each of the fiber receiving locations can include a first fiber contact surface and a second fiber contact surface that are each adapted to contact a corresponding one of the optical fibers when the optical fiber is received in the fiber receiving location. The first and second fiber contact surfaces of each of the fiber receiving locations can be relatively oriented to define a fiber receiving angle that is greater than 90 degrees. The positioning arrangement can also include a pressing structure with pressing surfaces for opposing the row of fiber receiving locations to press the optical fibers within the fiber receiving locations.

### CROSS-REFERENCE TO RELATED APPLICATIONS

This application is a Continuation of International Patent Application No. PCT/US2021/054524, filed on Oct. 12, 2021, which claims the benefit of U.S. Patent Application Ser. No. 63/091,070, filed on Oct. 13, 2020, the disclosures of which are incorporated herein by reference in their entireties. To the extent appropriate, a claim of priority is made to each of the above disclosed applications.

### TECHNICAL FIELD

The present disclosure relates generally to multi-fiber connectivity. More particularly, the present disclosure relates to a fiber positioning arrangement for optical fiber alignment systems and connector system.

### BACKGROUND

Fiber optic connectors are commonly used in optical fiber communication systems to effect dematable optical connections between waveguides such as optical fibers. A typical fiber optic connector includes a ferrule assembly supported at a distal end of a connector housing. When two fiber optic connectors are interconnected, the distal end faces of the ferrules abut one another, and the ferrules are forced proximally relative to their respective connector housings against the bias of their respective springs. With the fiber optic connectors connected, their respective optical fibers are coaxially aligned such that the end faces of the optical fibers directly oppose one another.

Another type of fiber optic connector can be referred to as a ferrule-less fiber optic connector or bare fiber optic connector. In a bare fiber optic connector, an end portion of an optical fiber corresponding to the bare fiber optic connector is not supported by a ferrule. Instead, the end portion of the optical fiber is a free end portion. Similar to the ferruled connectors described above, bare fiber optic adapters can be used to assist in optically coupling together two bare fiber optic connectors.

V-grooves are commonly used in prior-art ferrule-less fiber optic alignment devices. An example is the V-groove method described in U.S. Pat. No. 6,516,131 used for alignment of optical fiber ends. Optical fibers are pressed into the V-grooves and line contact between the optical fibers and the surfaces of the V-grooves assists in providing precise alignment of the optical fibers. In one example, two optical fibers desired to be optically connected together are positioned end-to-end within a V-groove such that the V-groove functions to co-axially align the optical fibers. End faces of the aligned optical fibers can abut one another.

### SUMMARY

The present disclosure relates generally to a positioning arrangement for positioning optical fibers. The positioning arrangement includes a positioning substrate that has a plurality of parallel fiber receiving grooves arranged in a row. Each of the fiber receiving grooves can be configured to receive two of the optical fibers. Each of the fiber receiving grooves can be defined by a bed surface and first and second angled surfaces. The first angled surfaces and the bed surfaces cooperate to define first fiber receiving locations of each of the fiber receiving grooves. The second angled surfaces and the bed surfaces cooperate to define second fiber receiving locations of each of the fiber receiving grooves. Each of the first and second fiber receiving locations define a fiber receiving angle greater than 90 degrees. The positioning arrangement can further include a pressing structure that includes pressing surfaces for opposing the first and second fiber receiving locations to press the optical fibers within the first and second fiber receiving locations.

Another aspect of the present disclosure relates to a positioning arrangement for positioning optical fibers. The positioning arrangement includes a positioning substrate that has a plurality of fiber receiving locations arranged in a row.

Each of the fiber receiving locations can be configured to receive one of the optical fibers. Each of the fiber receiving locations include a first fiber contact surface and a second fiber contact surface that are each adapted to contact a corresponding one of the optical fibers when the optical fiber is received in the fiber receiving location. The first and second fiber contact surfaces of each of the fiber receiving locations can be relatively oriented to define a fiber receiving angle that is greater than 90 degrees. The positioning arrangement can further include a pressing structure that has pressing surfaces for opposing the row of fiber receiving locations to press the optical fibers within the fiber receiving locations.

As used herein, the term “optical fiber” relates to an optical transmission element. In certain examples, the optical fiber can have a core size between 8-12 micrometers in outer diameter, a cladding layer with an outer diameter of 120-130 micrometers, and a coating layer (e.g., a polymeric coating such as acrylate) with an outer diameter of 190-260 micrometers. Aspects of the present disclosure are also applicable to multi-mode optical fibers.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates a multi-fiber optical connector system including a cable, a first connector, a second connector mated with the first connector, and a plurality of optical fibers arranged in rows in accordance with the principles of the present disclosure.

FIG. 2 illustrates the multi-fiber optical connector system of FIG. 1 with the first and second connectors unmated to show a stack of positioning arrangements positioned within the first connector in accordance with the principles of the present disclosure.

FIG. 3 illustrates a perspective view of the first connector shown in FIG. 1 with the cable removed.

FIG. 4 illustrates a perspective view of the second connector shown in FIG. 1 including a stack of positioning arrangements and shutters in an open position in accordance with the principles of the present disclosure.

FIG. 5 illustrates another perspective view of the second connector of FIG. 4 with the shutters in a closed position.

FIG. 6 illustrates a sectional view showing the first connector fully inserted within the second connector with the shutters opened.

FIG. 7 illustrates a sectional view of the first connector partially inserted in the second connector with the shutters in the closed position.

FIG. 8 illustrates a perspective view of one of the positioning arrangements of FIG. 3, the positioning arrangement including a positioning substrate and a pressing structure.

FIG. 9 illustrates a first side perspective view of the positioning substrate of FIG. 8.

FIG. 10 illustrates an opposite, second side perspective view of the positioning substrate of FIG. 8.

FIG. 11 illustrates a first side perspective view of the pressing structure of FIG. 8.

FIG. 12 illustrates an opposite, second side perspective view of the pressing structure of FIG. 11.

FIG. 13 illustrates an end view of the pressing structure of FIG. 8.

FIG. 14 illustrates an end view of the positioning arrangement of FIG. 8.

FIG. 15 illustrates an enlarged view of a portion of the positioning arrangement shown in FIG. 14.

FIG. 16 illustrates a perspective front view of the first connector of FIG. 3.

FIG. 17 illustrates a perspective view of a bare fiber alignment system including a stack of bare fiber alignment devices positioning a plurality of optical fibers in parallel rows in accordance with the principles of the present disclosure.

FIG. 18 illustrates a perspective view of another bare fiber alignment system with less rows and more optical fibers in accordance with the principles of the present disclosure.

FIG. 19 illustrates a perspective view of one of the bare fiber alignment devices of FIG. 17.

FIG. 20 illustrates an end view of the bare fiber alignment device of FIG. 19.

FIG. 21 illustrates a schematic view depicting an angle orientation of a fiber receiving location with an optical fiber in accordance with the principles of the present disclosure.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

As used herein, a bare fiber is a section of optical fiber that does not include any coating. Instead, the bare fiber includes a core surrounded by a cladding layer. The optical fiber is “bare” because the cladding layer is exposed and not covered by a supplemental coating layer such as acrylate.

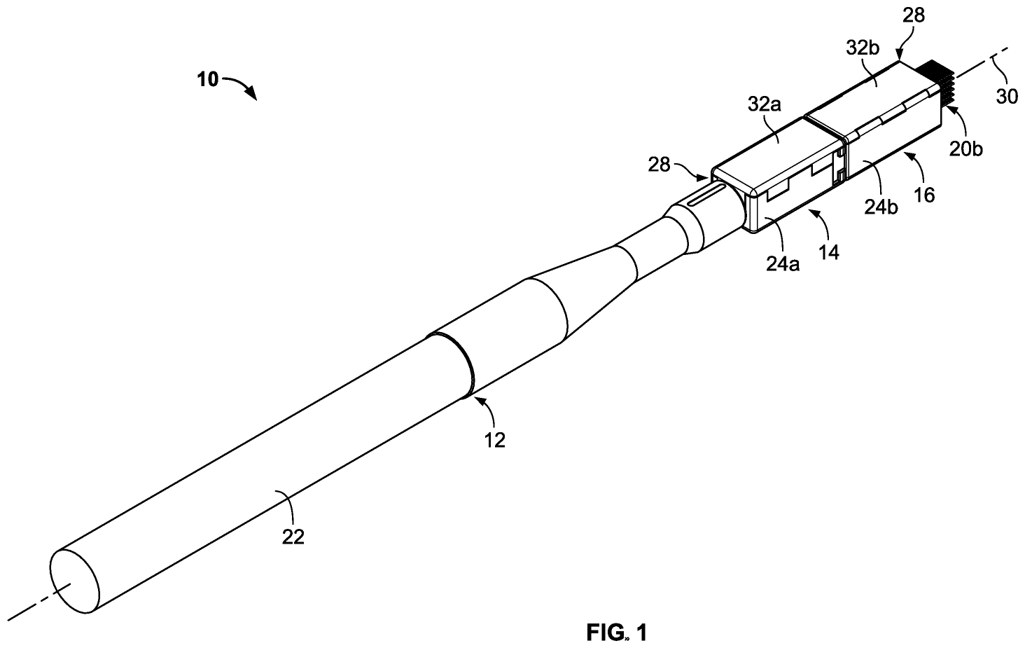

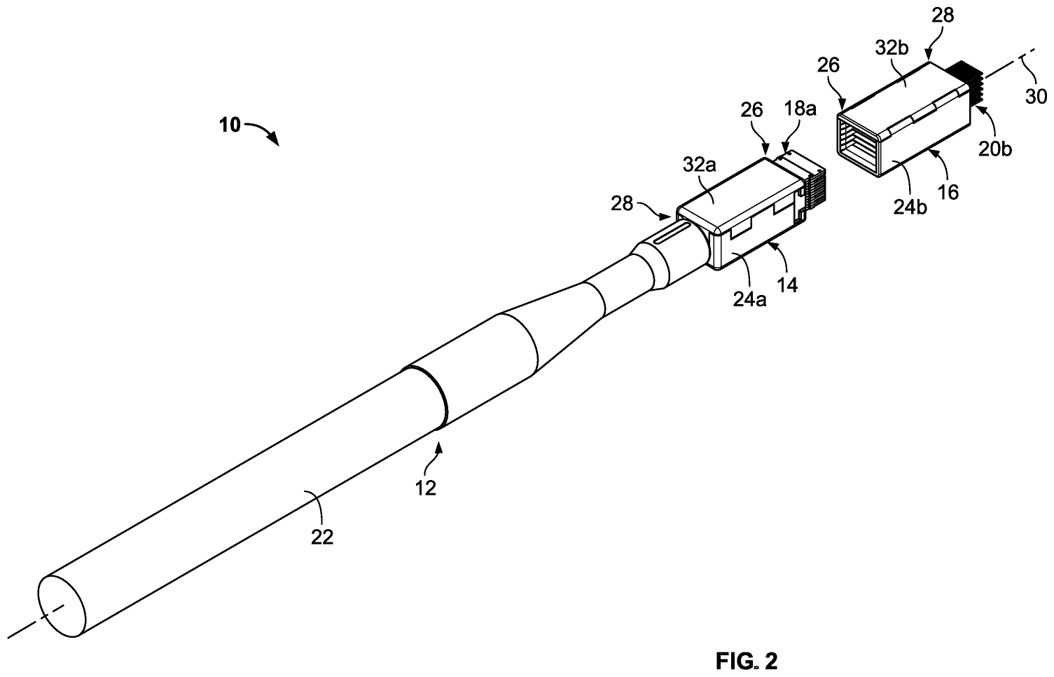

FIGS. 1-2 depict a multi-fiber optical connector system 10 in accordance with the principles of the present disclosure shown with a cable 12, a first connector 14 (e.g., a male connector), and a mating second connector 16 (e.g., a female connector).

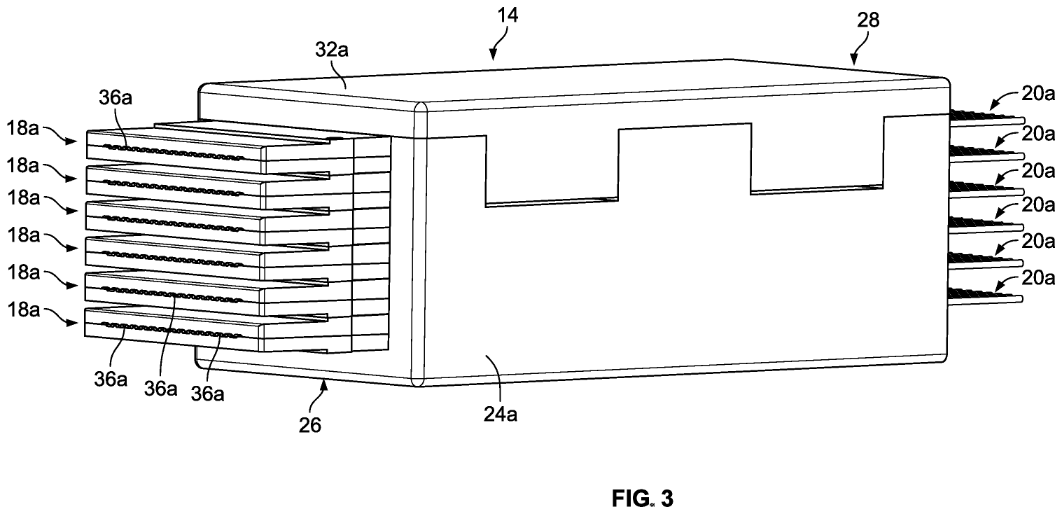

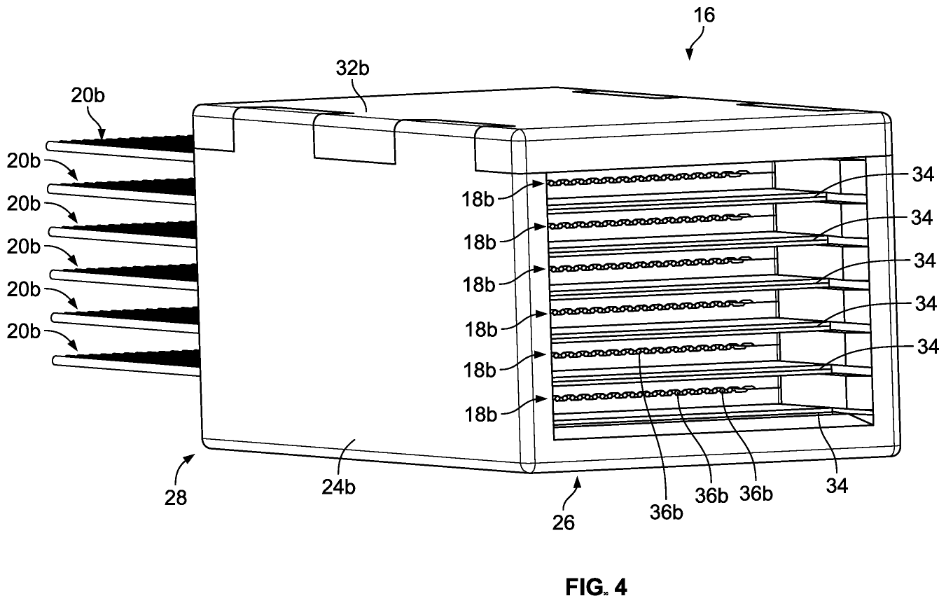

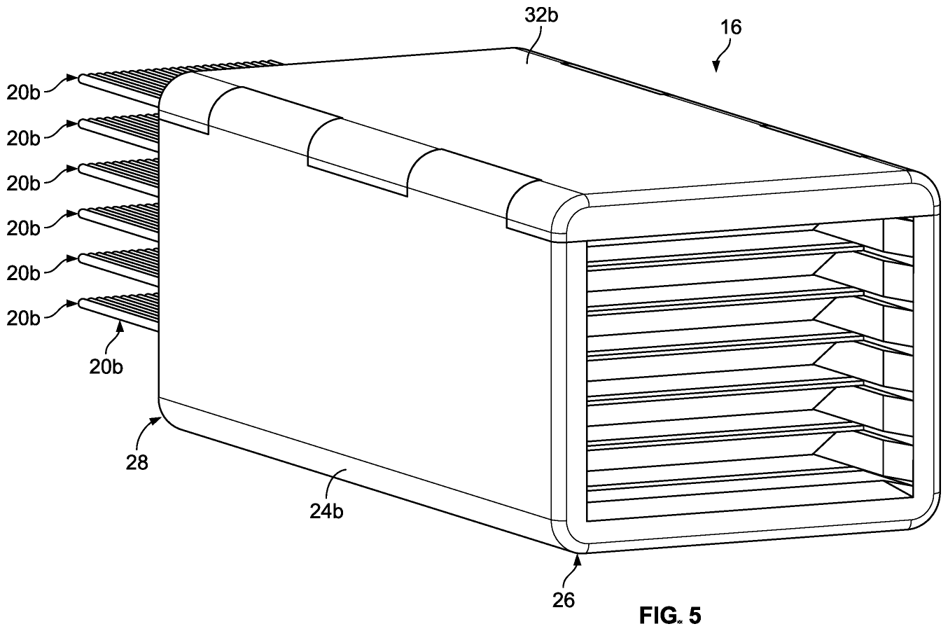

Turning to FIGS. 3-7, the multi-fiber optical connector system 10 includes multiple positioning arrangements 18 (e.g., fiber holders) respectively stacked together within the first and second connectors 14, 16. In the example shown, six positioning arrangements 18a, 18b are respectively stacked together in the first and second connectors 14, 16, although alternatives are possible. Each one of the respective positioning arrangements 18a, 18b includes a plurality of optical fibers 20a, 20b that may be ribbonized, buffered, or otherwise contained within a passage of an outer jacket 22 of the cable 12. In certain examples, the plurality of optical fibers 20a, 20b can be arranged in parallel relationship to form a ribbon. It will be appreciated that ribbons of different configuration may be used. As depicted, the positioning arrangements 18a, 18b each include twenty-four optical fibers 20a, 20b to provide connectors adapted to be compatible with a 144 optical fiber count cable 12. In certain examples, however, the cable 12 may include a greater or lesser number of optical fibers 20 (e.g., twenty-four, thirty-six, seventy-two, two hundred eighty-eight etc.) and the first and second connectors 14, 16 can have different numbers of positioning arrangements 18a, 18b selected to correspond with the number of fibers present in the cables to which the first and second connectors 14, 16 are secured. Each of the optical fibers 20a, 20b has a core and a cladding.

The first and second connectors 14, 16 each include a connector body 24a, 24b (e.g., a base, a bottom) that has a front end 26 and an opposite rear end 28. Each of the connector bodies 24a, 24b define a longitudinal axis 30 that extends through the connector bodies 24a, 24b in an orientation from the front ends 26 to the rear ends 28. The connector bodies 24a, 24b each define a receptacle 30 that extends between the front and rear ends 26, 28. The receptacles 30 of the respective connector bodies 24a, 24b are designed to hold multiple positioning arrangements 18a, 18b stacked together. The first and second connectors 14, 16 can each include a cover 32a, 32b (e.g., a top) configured to close the receptacles 30 of the respective connector bodies 24a, 24b. The covers 32a, 32b can be respectively retained to the connector bodies 24a, 24b by a snap-fit connection, a press-fit connection, an adhesive connection or other type of connection.

The second connector 16 includes shutters 34 inside the connector body 24b that are configured to automatically open when the first connector 14 is inserted and automatically close when the first connector 14 is retracted. FIG. 7 shows the first connector 14 partially inserted in the second connector 16 with the shutters 34 in the closed position. When the first connector 14 is fully inserted into the second connector, the shutters 34 are in the open position. The shutters 34 of the second connector 16 are adapted to apply a spring force on the positioning arrangements 18a of the first connector 14 when the first connector 14 is fully inserted in the second connector 14 to assist providing alignment of the positioning arrangements 18a of the first connector 14 with the positioning arrangements 18b of the second connector 16. The shutters 34 are configured to cover the positioning arrangements 18b and thereby shield and protect bare fiber ends 36b of the optical fibers 20b from contamination. A dust cap (not shown) can mount over the first connector 14 to cover the positioning arrangements 18a and thereby shield and protect bare fiber ends 36a of the optical fibers 20a from contamination.

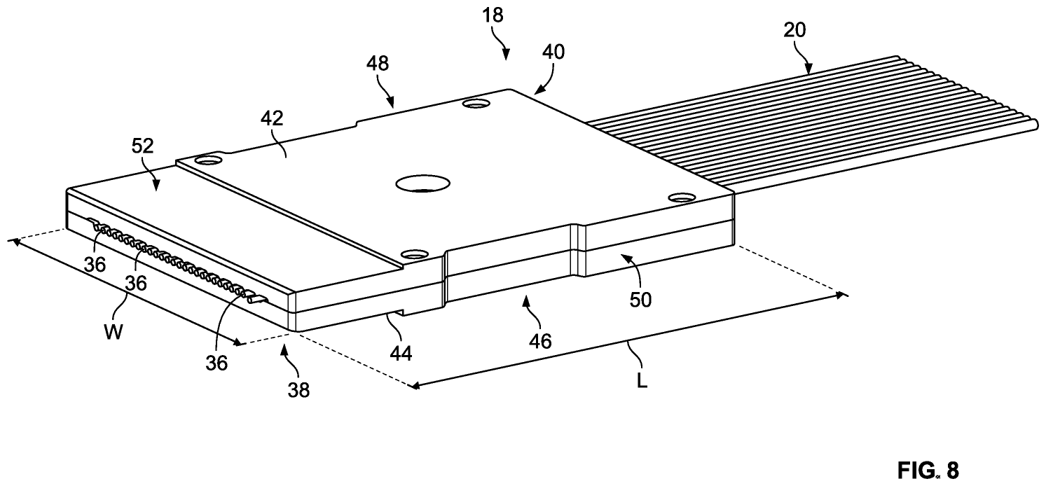

Referring to FIG. 8, the positioning arrangement 18 is depicted. The positioning arrangement 18 has a first end 38, an opposite second end 40, a top side 42, an opposite, bottom side 44, a first side 46, and an opposite second side 48. The positioning arrangement 18 has a length L that extends between the first and second ends 38, 40 of the positioning arrangement 18 and a width W that extends between the first and second sides 46, 48 of the positioning arrangement 18.

The plurality of optical fibers 20 are shown routed through the positioning arrangement 18 from the first end 38 to the second end 40. The optical fibers 20 can enter the positioning arrangement 18 at the second end 40 such that the bare fiber ends 36 are accessible at the first end 38 of the positioning arrangement 18. In the depicted example, the bare fiber ends 36 project slightly from the first end 38 of the positioning arrangement 18, but in alternative examples could be flush or slightly recessed relative to the first end 38. In examples in which the optical fibers 20 are recessed, flush, or protrude only slightly from the first end 38 of the positioning arrangement 18, fiber alignment can be achieved indirectly via relative positioning and alignment of the positioning arrangements 18a, 18b relative to one another. In other examples, the bare optical fibers can project more significantly beyond (e.g., more than 2 millimeters) the first ends 38 of the positioning arrangements 18a, 18b and can be adapted to be aligned by bare fiber alignment structures such as v-grooves or other types of grooves. Example bare fiber alignment structures and systems are disclosed by PCT Publication Nos. WO 2020/112645; WO 2020/046709; WO 2019/079326; WO 2017/081306; WO 2016/1003384 and U.S. Pat. No. 9,575,272, the disclosures of which are hereby incorporated by reference in their entireties.

The positioning arrangements 18 can each include a positioning substrate 50 and a pressing structure 52 formed by a molding process. In other examples, the positioning arrangements 18 can include a one-piece body formed by a molding process. The positioning substrate 50 and the pressing structure 52 together form an enclosed area for supporting the optical fibers 20. The positioning substrate 50 and the pressing structure 52 can be connected by a snap-fit connection, a press-fit connection, an adhesive connection, or other type of connection.

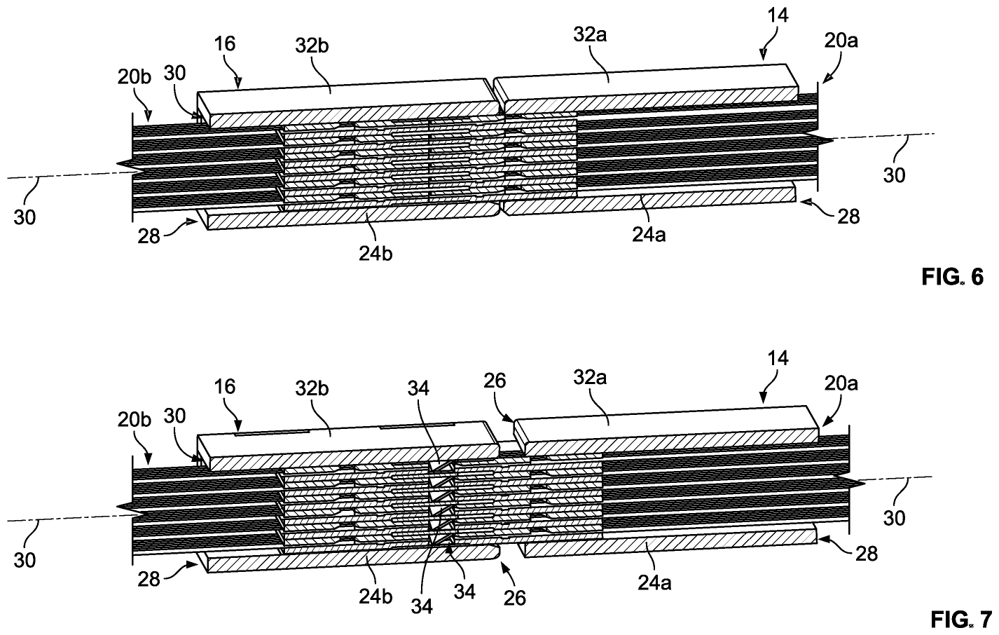

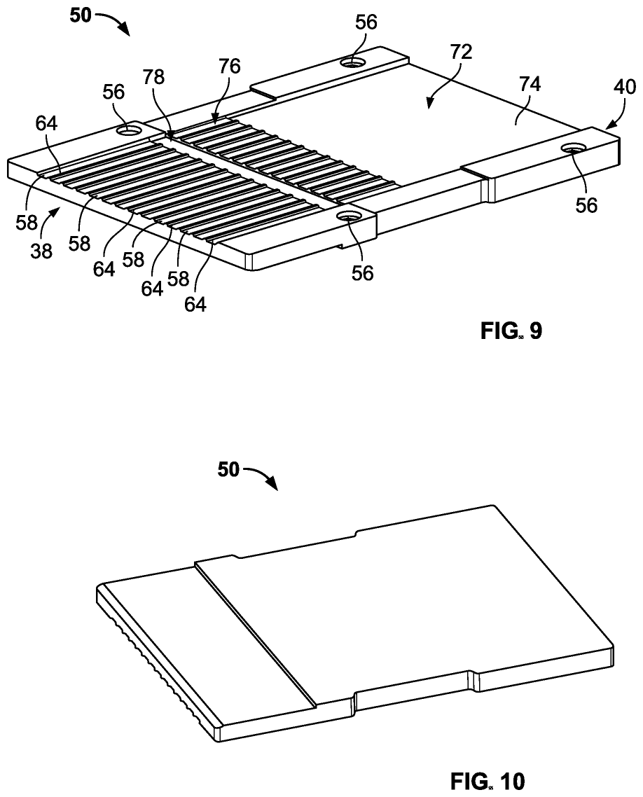

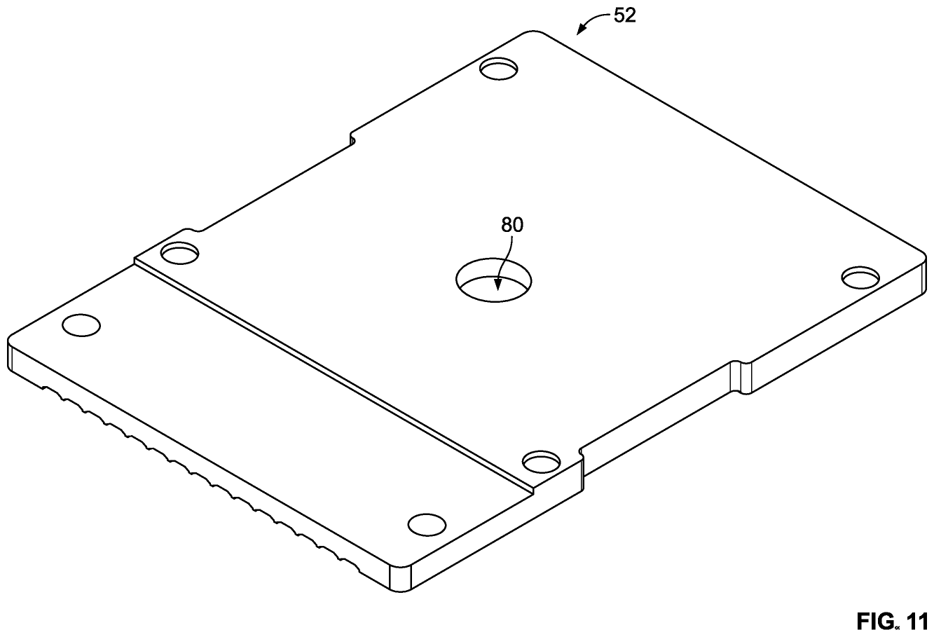

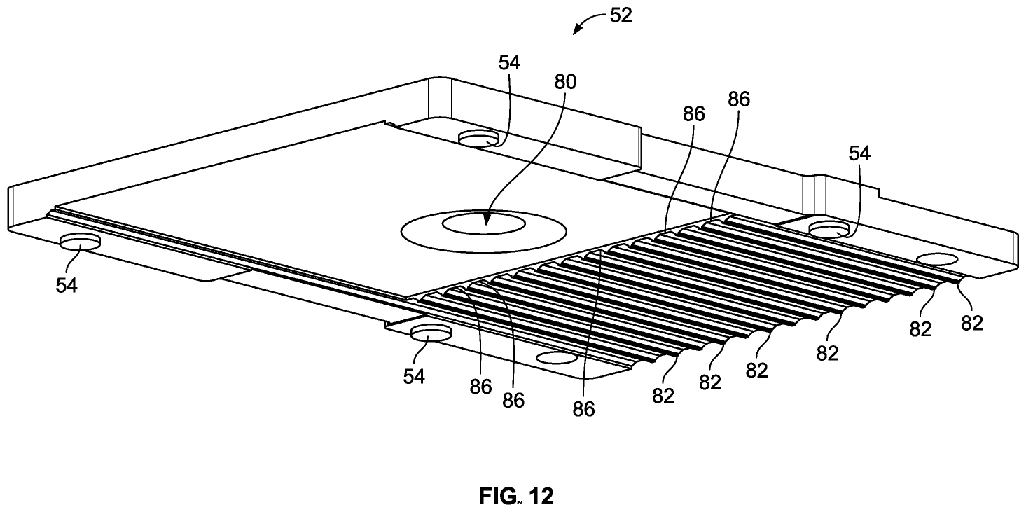

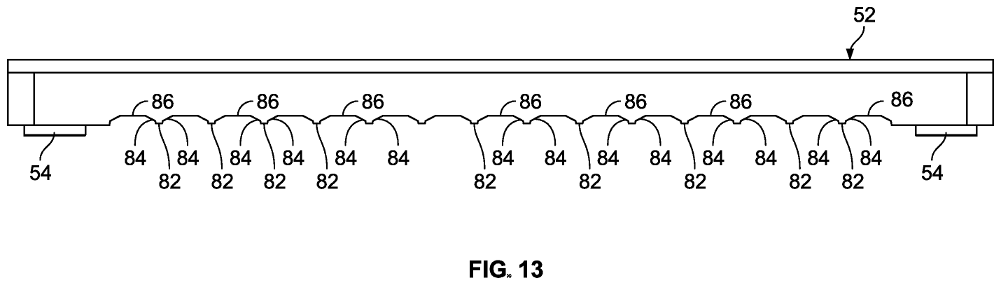

Turning to FIGS. 9-13, the pressing structure 52 include pegs 54 that are configured to engage respective openings 56 defined in the positioning substrate 50 to mount the positioning substrate 50 and the pressing structure 52 together and to provide alignment between the positioning substrate 50 and the pressing structure 52. The positioning substrate 50 and the pressing structure 52 can be incorporated in a fiber optic connector. The positioning substrate 50 and the pressing structure 52 can be configured to position the optical fibers 20 within a connector body. As depicted in FIGS. 6-7, a plurality of the positioning substrates 50 and pressing structures 52 can be stacked within the connector bodies 24a, 24b to position the optical fibers 20a, 20b in a plurality of parallel rows within the connector bodies 24a, 24b, respectively.

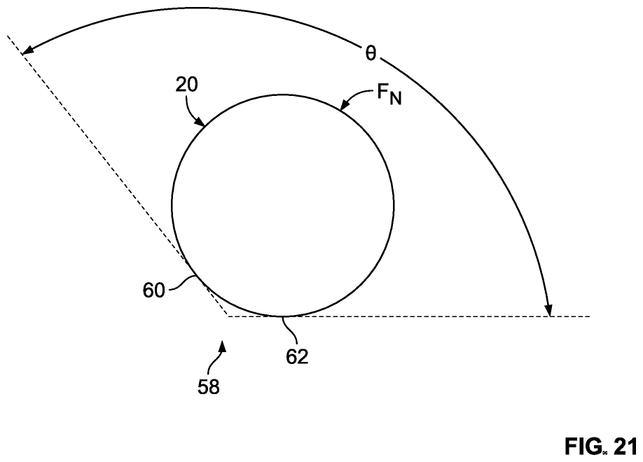

The positioning substrate 50 includes a plurality of fiber receiving locations 58 arranged in a row. Each of the fiber receiving locations 58 can be configured to receive one of the plurality of optical fibers 20. Each of the fiber receiving locations 58 can include a first fiber contact surface 60 and a second fiber contact surface 62 each adapted to contact a corresponding one of the optical fibers 20 when the optical fiber 20 is received in the fiber receiving location 58 (see FIG. 21) with a normal force applied on top of the optical fiber 20. The first and second fiber contact surfaces 60, 62 of each of the fiber receiving locations 58 can be relatively oriented to define a fiber receiving angle e (see FIG. 21) that is greater than 90 degrees.

The positioning substrate 50 also includes a plurality of parallel fiber receiving grooves 64 arranged in a row. Each of the plurality of parallel fiber receiving grooves 64 can be configured to receive two of the optical fibers 20. Each of the plurality of parallel fiber receiving grooves 64 can be defined by a bed surface 66 and first and second angled surfaces 68, 70. The first angled surfaces 68 and the bed surfaces 66 cooperate to define first fiber receiving locations 58a of each of the fiber receiving grooves 64. The second angled surfaces 70 and the bed surfaces 66 cooperate to define second fiber receiving locations 58b of each of the fiber receiving grooves 64. Each of the first and second fiber receiving locations 58a, 58b also define the fiber receiving angle e.

The fiber receiving angles e defined by the first and second fiber contact surfaces 60, 62 of each of the fiber receiving locations 58 and the fiber receiving angles e defined by the first and second fiber receiving locations 58a, 58b can each be equal to or greater than 100 degrees, although alternatives are possible. In certain examples, the fiber receiving angles e are each equal to or greater than 110 degrees. In still other examples, the fiber receiving angles e are each equal to or greater than 120 degrees.

The positioning substrate 50 can include a fiber anchoring region 72 (e.g., fiber mating region) adjacent the second end 40. The fiber anchoring region 72 can be provided for securing the optical fibers 20 to the positioning arrangement 18 with adhesive (e.g., epoxy). The fiber anchoring region 72 can include a non-grooved section 74 for receiving coated portions 22 of the optical fibers 20 and a grooved portion 76 that extends from the non-grooved portion 74 to a cross-channel 78 that functions as an epoxy stop. The fiber receiving grooves 64 can extend from the cross-channel 78 to the first end 38. The grooved portion 76 can also receive the bare fiber ends 36 of the optical fibers 20.

The pressing structure 52 can include a port 80 for injecting epoxy into the fiber anchoring region 72 once the pressing structure 52 has been mounted to the positioning substrate 50 for securing the optical fibers 20 to the positioning arrangement 18. The pressing structure 52 includes projections 82 that each include pressing surfaces 84 that oppose the row of fiber receiving locations 58 to press the optical fibers 20 within the fiber receiving locations 58. The projections 82 extend from groove bed surfaces 86. The pressing surfaces 84 are angled with respect to the groove bed surfaces 86 of the pressing structure 52.

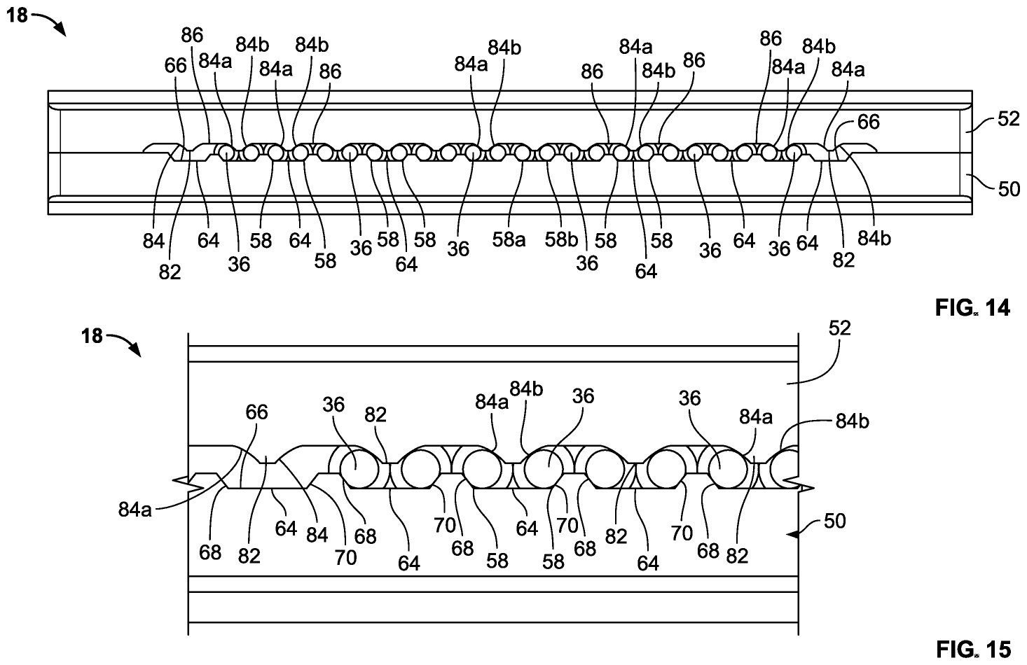

Turning to FIGS. 14-15, when the positioning substrate 50 and the pressing structure 52 are mated together with the optical fibers 20 retained within the fiber receiving grooves 64, first and second pressing surfaces 84a, 84b of each pressing structure 52 are configured to respectively engage the bare fiber ends 36 of two optical fibers 20. When the positioning substrate 50 and the pressing structure 52 are stacked together, each projection 82 is generally centered with respect to a corresponding one of the fiber receiving grooves 64 with one of the pressing surfaces 84a of the projection 82 being adapted to press an optical fiber 20 within the fiber receiving location 58a of the fiber receiving groove 64 and the other of the pressing surfaces 84b of the projection 82 being adapted to press an optical fiber 20 within the fiber receiving location 58b of the fiber receiving groove 64. That is, when the positioning substrate 50 and the pressing structure 52 are stacked, the first pressing surfaces 84a engage one of two optical fibers 20 positioned in the plurality of parallel fiber receiving grooves 64 and the second pressing surfaces 84b engage the other one of the two optical fibers 20 positioned in the plurality of parallel fiber receiving grooves 64.

The pressing surfaces 84a, 84b are oriented at oblique angles (e.g., in the range of 70-20 degrees or 60-30 degrees) relative to the bed surfaces 66 of the fiber receiving grooves 64. The groove bed surfaces 86 bridge across projections 82 defined between the fiber receiving grooves 64. The projections 82 define the first and second angled surfaces 68, 70 of the fiber receiving locations 58.

The empty fiber receiving grooves 64 are extra grooves that can be used to apply guiding pins or special guiding features if desired.

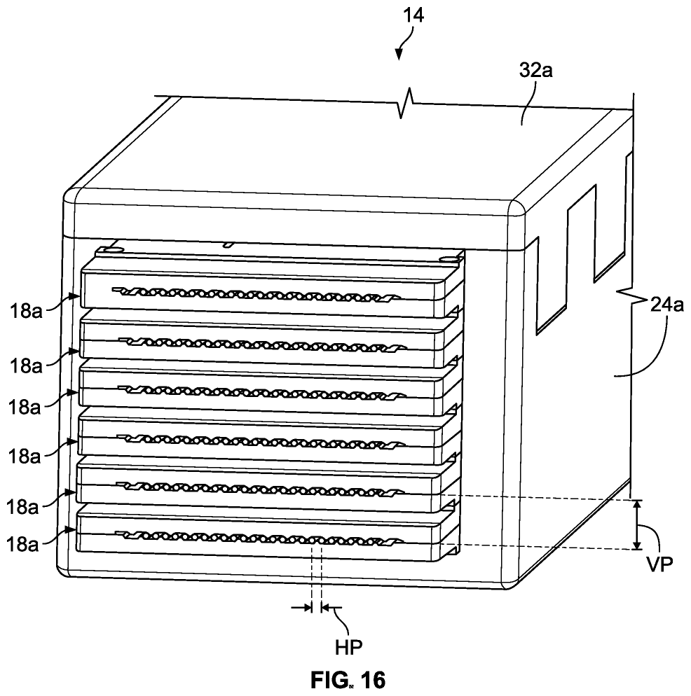

Referring to FIG. 16, the optical fibers 20 may be spaced apart to define a gap between each optical fiber 20 making a pitch (i.e., center to center spacing). Example pitches include 250 micrometers and 200 micrometers. The positioning arrangement 18 can establish a distance from a point on one optical fiber to a corresponding point on an adjacent optical fiber as measured across a horizontal axis between adjacent optical fibers in the positioning arrangement 18. The fiber receiving grooves 64 of the positioning arrangements 18 can define a horizontal fiber pitch HP of 250 micrometers or less or 200 micrometers or less, although alternatives are possible. A vertical fiber pitch VP of about 1000 micrometers or less can be defined between stacked positioning arrangements 18 within the first connector 14, although alternatives are possible.

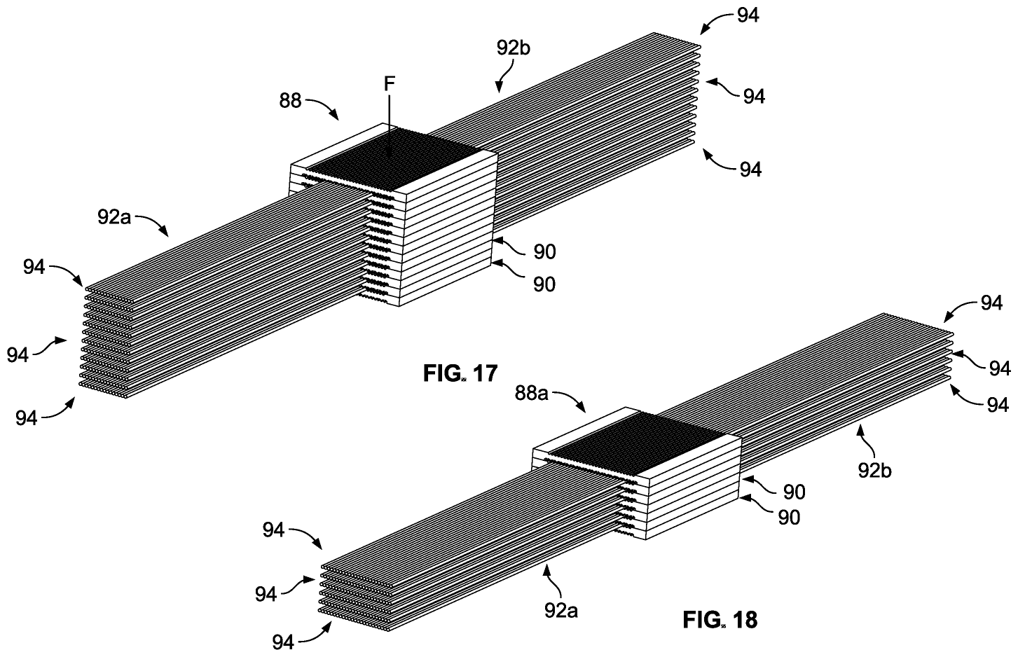

Turning to FIG. 17, a 144 bare fiber alignment system 88 is depicted. The bare fiber alignment system 88 can include a bare fiber alignment device 90 for aligning first and second pluralities of optical fibers 92a, 92b. The optical fibers 92a, 92b can be arranged in sets of parallel rows. As depicted, the bare fiber alignment system 88 includes a stack of bare fiber alignment devices 90 configured to position the opposing first and second pluralities of optical fibers 92a, 92b in a plurality of parallel rows 94 with bare fiber ends of the plurality of optical fibers 92a, 92b being co-axially aligned such that optical signals can be conveyed between the plurality of optical fibers 92a, 92b held by the bare fiber alignment devices 90. The bare fiber alignment device 90 accommodates sixteen opposing optical fibers 92a, 92b for each row of the bare fiber alignment system 88, although alternatives are possible. Although the bare fiber alignment system 88 is depicted with nine rows, alternatives are possible.

FIG. 18 shows a 144 bare fiber alignment system 88a that has six bare fiber alignment devices 90 stacked together so as to accommodate the coupling of six rows 94 of optical fibers. Each row 94 has twenty-four opposing optical fibers 92a, 92b positioned in the bare fiber alignment devices 90.

The bare fiber alignment systems 88, 88a provide a horizontal fiber pitch HP of less than or equal to about 250 microns or less than or equal to about 200 micrometers and a vertical fiber pitch VP of less than or equal to about 500 micrometers, although alternatives are possible.

In certain examples, the bare fiber alignment systems 88, 88a can be mounted in a multi-fiber fiber optic adapter (not shown) such that spring force F can be applied to the top of the bare fiber alignment device 90. The spring force F can be transferred through the stack of bare fiber alignment devices 90 down to the bottom bare fiber alignment device 90.

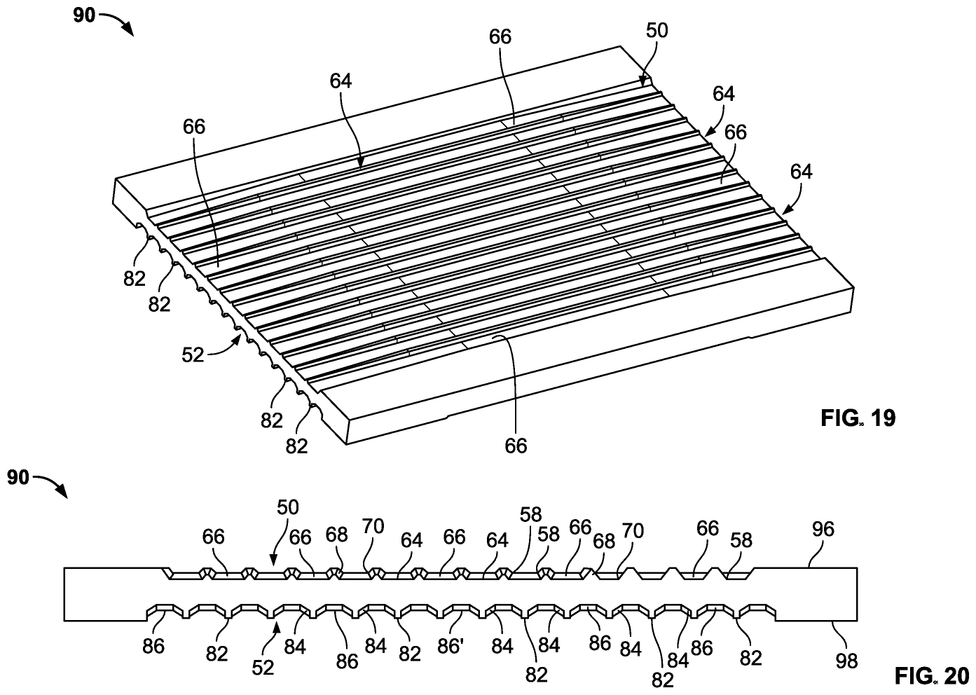

Turning to FIGS. 19-20, the bare fiber alignment device 90 is depicted. The positioning substrate 50 and the pressing structure 52 can be incorporated in the bare fiber alignment device 90. In the bare fiber alignment systems 88, 88a, a plurality of the bare fiber alignment devices 90 are stacked together such that a plurality of positioning substrates 50 and a plurality of pressing surfaces 84 are provided in the bare fiber alignment systems 88, 88a. In certain examples, a plurality of the positioning substrates 50 can be stacked within the bare fiber alignment systems 88, 88a.

In certain examples, each bare fiber alignment device 90 incudes a first side 96 adapted to function as a positioning substrate 50 and a second opposite side 98 adapted to function as a pressing structure 52. At least some of the first sides 96 include the fiber receiving locations 58 and at least some of the second sides 98 include the pressing surfaces 84. When the bare fiber alignment devices 90 are stacked, the first and second sides 96, 98 of adjacent ones of the bare fiber alignment devices 90 oppose one another with coupled rows of optical fibers 20 positioned between the opposing first and second sides 96, 98. Thus, each of the fiber row pairs that are coupled together are aligned between a pressing structure 52 defined by one of the bare fiber alignment devices 90 of the stack and a positioning substrate 50 defined by an adjacent one of the bare fiber alignment devices 90 of the stack. The optical fibers 20 are secured in fiber receiving locations 58 of the substrates 50 by pressing surfaces 84 of the pressing structures 52 in the same manner described herein with respect to the earlier embodiments.

### EXAMPLE ASPECTS OF THE DISCLOSURE

Aspect 1. A positioning arrangement for positioning optical fibers, the positioning arrangement comprising:

a positioning substrate including a plurality of fiber receiving locations arranged in a row, each of the fiber receiving locations being configured to receive one of the optical fibers, each of the fiber receiving locations including a first fiber contact surface and a second fiber contact surface each adapted to contact a corresponding one of the optical fibers when the optical fiber is received in the fiber receiving location, the first and second fiber contact surfaces of each of the fiber receiving locations being relatively oriented to define a fiber receiving angle that is greater than 90 degrees; and

a pressing structure including pressing surfaces for opposing the row of fiber receiving locations to press the optical fibers within the fiber receiving locations.

Aspect 2. The fiber positioning arrangement of aspect 1, wherein the fiber receiving angles are each equal to or greater than 100 degrees.
Aspect 3. The fiber positioning arrangement of aspect 1, wherein the fiber receiving angles are each equal to or greater than 110 degrees.
Aspect 4. The fiber positioning arrangement of aspect 1, wherein the fiber receiving angles are each equal to or greater than 120 degrees.
Aspect 5. The positioning arrangement of aspect 1, wherein the positioning substrate and the pressing structure are incorporated in a fiber optic connector.
Aspect 6. The positioning arrangement of aspect 5, wherein the fiber optic connector includes shutters.
Aspect 7. The positioning arrangement of aspect 5, wherein the positioning substrate and the pressing structure position the optical fibers within a connector body.
Aspect 8. The positioning arrangement of aspect 7, wherein a plurality of the positioning substrates and pressing structures are stacked within the connector body to position the optical fibers in a plurality of parallel rows within the connector body.
Aspect 9. The positioning arrangement of aspect 1, wherein the positioning substrate and the pressing structure are incorporated in a bare fiber alignment device.
Aspect 10. The positioning arrangement of aspect 9, wherein a plurality of bare fiber alignment devices are stacked, wherein the plurality of bare fiber alignment devices include first sides and opposite second sides, and wherein at least some of the first sides include the fiber receiving locations and at least some of the second sides include the pressing surfaces.
Aspect 11. A positioning arrangement for positioning optical fibers, the positioning arrangement comprising:

a positioning substrate including a plurality of parallel fiber receiving grooves arranged in a row, each of the fiber receiving grooves each being configured to receiving two of the optical fibers, each of the fiber receiving grooves being defined by a bed surface and first and second angled surfaces, the first angled surfaces and the bed surfaces cooperating to define first fiber receiving locations of each of the fiber receiving grooves, the second angled surfaces and the bed surfaces cooperating to define second fiber receiving locations of each of the fiber receiving grooves, each of the first and second fiber receiving locations defining a fiber receiving angle greater than 90 degrees; and

a pressing structure including pressing surfaces for opposing the first and second fiber receiving locations to press the optical fibers within the first and second fiber receiving locations.

Aspect 12. The fiber positioning arrangement of aspect 11, wherein the fiber receiving angles are each equal to or greater than 100 degrees.
Aspect 13. The fiber positioning arrangement of aspect 11, wherein the fiber receiving angles are each equal to or greater than 110 degrees.
Aspect 14. The fiber positioning arrangement of aspect 11, wherein the fiber receiving angles are each equal to or greater than 120 degrees.
Aspect 15. The positioning arrangement of aspect 11, wherein the positioning substrate and the pressing structure are incorporated in a fiber optic connector.
Aspect 16. The positioning arrangement of aspect 15, wherein the fiber optic connector includes shutters.
Aspect 17. The positioning arrangement of aspect 15, wherein the positioning substrate and the pressing structure position the optical fibers within a connector body.
Aspect 18. The positioning arrangement of aspect 17, wherein a plurality of the positioning substrates and pressing structures are stacked within the connector body to position the optical fibers in a plurality of parallel rows within the connector body.
Aspect 19. The positioning arrangement of aspect 1, wherein the positioning substrate and the pressing structure are incorporated in a bare fiber alignment device.
Aspect 20. The positioning arrangement of aspect 19, wherein a plurality of bare fiber alignment devices are stacked, wherein the plurality of bare fiber alignment devices include first sides and opposite second sides, and wherein at least some of the first sides include the fiber receiving locations and at least some of the second sides include the pressing surfaces.

From the forgoing detailed description, it will be evident that modifications and variations can be made without departing from the spirit and scope of the disclosure.

What is claimed is:

1. A positioning arrangement for positioning optical fibers, the positioning arrangement comprising:
a positioning substrate including a plurality of fiber receiving locations arranged in a row, each of the fiber receiving locations being configured to receive one of the optical fibers, each of the fiber receiving locations including a first fiber contact surface and a second fiber contact surface each adapted to contact a corresponding one of the optical fibers when the optical fiber is received in the fiber receiving location, the first and second fiber contact surfaces of each of the fiber receiving locations being relatively oriented to define a fiber receiving angle that is greater than 90 degrees; and
a pressing structure including pressing surfaces for opposing the row of fiber receiving locations to press the optical fibers within the fiber receiving locations.

2. The fiber positioning arrangement of claim 1, wherein the fiber receiving angles are each equal to or greater than 100 degrees.

3. The fiber positioning arrangement of claim 1, wherein the fiber receiving angles are each equal to or greater than 110 degrees.

4. The fiber positioning arrangement of claim 1, wherein the fiber receiving angles are each equal to or greater than 120 degrees.

5. The positioning arrangement of claim 1, wherein the positioning substrate and the pressing structure are incorporated in a fiber optic connector.

6. The positioning arrangement of claim 5, wherein the fiber optic connector includes shutters.

7. The positioning arrangement of claim 5, wherein the positioning substrate and the pressing structure position the optical fibers within a connector body.

8. The positioning arrangement of claim 7, wherein a plurality of the positioning substrates and pressing structures are stacked within the connector body to position the optical fibers in a plurality of parallel rows within the connector body.

9. The positioning arrangement of claim 1, wherein the positioning substrate and the pressing structure are incorporated in a bare fiber alignment device.

10. The positioning arrangement of claim 9, wherein a plurality of bare fiber alignment devices are stacked, wherein the plurality of bare fiber alignment devices include first sides and opposite second sides, and wherein at least some of the first sides include the fiber receiving locations and at least some of the second sides include the pressing surfaces.

11. A positioning arrangement for positioning optical fibers, the positioning arrangement comprising:
a positioning substrate including a plurality of parallel fiber receiving grooves arranged in a row, each of the fiber receiving grooves being configured to receive two of the optical fibers, each of the fiber receiving grooves being defined by a bed surface and first and second angled surfaces, the first angled surfaces and the bed surfaces cooperating to define first fiber receiving locations of each of the fiber receiving grooves, the second angled surfaces and the bed surfaces cooperating to define second fiber receiving locations of each of the fiber receiving grooves, each of the first and second fiber receiving locations defining a fiber receiving angle greater than 90 degrees; and
a pressing structure including pressing surfaces for opposing the first and second fiber receiving locations to press the optical fibers within the first and second fiber receiving locations.

12. The fiber positioning arrangement of claim 11, wherein the fiber receiving angles are each equal to or greater than 100 degrees.

13. The fiber positioning arrangement of claim 11, wherein the fiber receiving angles are each equal to or greater than 110 degrees.

14. The fiber positioning arrangement of claim 11, wherein the fiber receiving angles are each equal to or greater than 120 degrees.

15. The positioning arrangement of claim 11, wherein the positioning substrate and the pressing structure are incorporated in a fiber optic connector.

16. The positioning arrangement of claim 15, wherein the fiber optic connector includes shutters.

17. The positioning arrangement of claim 15, wherein the positioning substrate and the pressing structure position the optical fibers within a connector body.

18. The positioning arrangement of claim 17, wherein a plurality of the positioning substrates and pressing structures are stacked within the connector body to position the optical fibers in a plurality of parallel rows within the connector body.

19. The positioning arrangement of claim 1, wherein the positioning substrate and the pressing structure are incorporated in a bare fiber alignment device.

20. The positioning arrangement of claim 19, wherein a plurality of bare fiber alignment devices are stacked, wherein the plurality of bare fiber alignment devices include first sides and opposite second sides, and wherein at least some of the first sides include the first and second fiber receiving locations and at least some of the second sides include the pressing surfaces.
